(19) United States
(12) Patent Application Publication
(10) Pub. No.: US 2022/0340064 A1
(43) Pub. Date: Oct. 27, 2022

(54) VEHICLE SEAT ELEMENT LINING INTEGRATING A VIBRATING DEVICE

(71) Applicant: FAURECIA Sièges d'Automobile, Nanterre (FR)

(72) Inventors: Stéphane SOLTNER, MAILLERONCOURT CHARRETTE (FR); Jérôme PLANSON, ANGERVILLE (FR); Imen CHERIAA, ETAMPES (FR)

(21) Appl. No.: 17/724,974

(22) Filed: Apr. 20, 2022

(30) Foreign Application Priority Data
Apr. 22, 2021 (FR) 2104225

(51) Int. Cl. B60N 2/90; B60N 2/70; A61H 1/00

(52) U.S. Cl. CPC B60N 2/976; B60N 2/70; A61H 1/005; A61H 2201/0107; A61H 2201/0149; B29C 45/14

(57) ABSTRACT

A vehicle seat element lining comprises a cushioning comprising at least one first face intended to be oriented towards an occupant of the vehicle seat and a second face, opposite the first face, the cushioning having at least one hole opening on the first and/or the second face of the cushioning; at least one vibrating device disposed in a hole, each vibrating device comprising at least two first snap-fit reliefs; a plurality of distinct vibrating device brackets, each comprising a base, overmolded by the cushioning, and a second snap-fit relief, each vibrating device being fastened to at least two respective brackets, by snap-fitting the first and second snap-fit reliefs.

### PRIORITY CLAIM

This application claims priority to French Patent Application No. FR2104225, filed Apr. 22, 2021 , which is expressly incorporated by reference herein.

### BACKGROUND

The present disclosure relates to a vehicle seat element lining integrating a vibrating device. The present description also relates to a motor vehicle seat element comprising such a lining, a vehicle seat comprising such a motor vehicle seat element and a method for manufacturing such a lining.

### SUMMARY

According to the present disclosure, a vehicle seat element lining comprises a cushioning comprising at least one first face intended to be oriented towards an occupant of the vehicle seat and a second face, opposite the first face, the cushioning having at least one hole opening on the first and/or the second face of the cushioning, at least one vibrating device, each vibrating device being disposed in a respective hole, each vibrating device comprising at least two first snap-fit reliefs, and a plurality of distinct vibrating device brackets, each comprising a base, overmolded by the cushioning, and a second snap-fit relief, each vibrating device being fastened to at least two respective brackets, by snap-fitting a first snap-fit relief with a second snap-fit relief.

In illustrative embodiments, the cushioning makes it possible to absorb the vibrations emitted by the vibrating device that would tend to propagate in the frame equipped with the lining. Furthermore, the use of distinct brackets makes it possible to limit the transmission of vibrations emitted by each vibrating device to the cushioning.

In illustrative embodiments, the vehicle seat element lining comprises one or more of the following features, taken alone or in combination:

each hole opens on a single face of the cushioning, within the first face and the second face of the cushioning;

each hole opens on the first face of the cushioning, the hole preferably being plugged on the side of the first face of the cushioning, by a foam pad, attached in the hole and distinct from the cushioning, the foam pad being, also preferably, denser than the cushioning;

each hole opens on the second face of the cushioning, each hole preferably being devoid of foam pad plugging the hole on the side of the second face of the cushioning;

each vibrating device comprises a chassis forming the at least two first snap-fit reliefs, and a vibrating element fastened to the chassis;

the chassis includes a cylindrical portion mainly extending along a longitudinal axis and receiving the vibrating element, the at least two snap-fit reliefs being integral with the cylindrical portion;

each first snap-fit relief is connected to the cylindrical portion by a lug preferably extending radially and/or axially in relation to the cylindrical portion;

each second snap-fit relief comprises two elastic strips symmetrical in relation to a plane extending between the two strips, each strip comprising a free end folded in the direction of the other strip, the distance between the two free ends of the two strips being less than the thickness of the associated first snap-fit relief;

each first snap-fit relief comprises a cylindrical rod, preferably extending orthoradially in relation to the longitudinal direction of the cylindrical portion, if applicable;

each vibrating device comprises three distinct first snap-fit reliefs, particularly exactly three distinct first snap-fit reliefs, the three first snap-fit reliefs preferably being evenly distributed about the longitudinal axis of the cylindrical portion, if applicable;

the base of each bracket comprises a first tab, preferably two first tabs extending on either side of a second tab, each first tab preferably having holes, each first tab being overmoulded by the cushioning; and

the seat element is one of a seat base, a backrest, a headrest, an elbow rest, and a seat front of a length-adjustable seat base.

In illustrative embodiments, it is also described a motor vehicle seat comprising a seat base with a seat base frame, a backrest with a backrest frame, and at least one vehicle seat element lining such as described above, in all its combinations, each vehicle seat element lining preferably being fastened to the seat base frame, to the backrest frame or to a movable bracket in relation to the seat base frame.

In illustrative embodiments, it is described a method for manufacturing a vehicle seat element lining such as described above, in all its combinations, comprising the steps of:

i) providing the vibrating device brackets;

ii) overmoulding the cushioning on the vibrating device, the overmoulding being performed in such a way as to form the at least one hole opening on the first and/or the second face of the cushioning;

iii) inserting a vibrating device into each of at least one hole and fastening each vibrating device to the vibrating device brackets by snap-fitting the first and second snap-fit reliefs.

In illustrative embodiments, the at least one hole opening on the first face of the cushioning and the method comprises a step iv) subsequent to step iii) of plugging each hole on the side of the first face of the cushioning by means of a foam pad.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 schematically shows a side view of an example of vehicle seat;

FIG. 2 schematically shows in perspective view a first example of seat lining that may be implemented in the vehicle seat of FIG. 1;

FIG. 3 schematically shows an exploded view of the seat base lining of FIG. 2;

FIG. 4 schematically shows an example of vibrating device that may be implemented in the lining of FIGS. 2 and 3;

FIG. 5 schematically shows in perspective view a second example of seat base lining that may be implemented in the vehicle seat of FIG. 1; and

FIG. 6 schematically shows in sectional view a variant of the seat base of FIG. 1, the length of which is adjustable.

### DETAILED DESCRIPTION

In the various figures, the same references designate identical or similar elements. For the purpose of brevity, only the elements that are useful for the understanding of the embodiment described are shown in the figures and are described in a detailed manner in the following.

In the following description, when reference is made to absolute position qualifying terms, such as the terms “front”, “back”, “top”, “bottom”, “left”, “right”, etc., or relative position qualifying terms, such as the terms “above”, “below”, “upper”, “lower”, etc., or to orientation qualifying terms, such as “horizontal”, “vertical”, etc., reference is made, unless otherwise specified, to the orientation of the figures or of a vehicle seat in its normal position of use.

In particular, the longitudinal direction X extends in the longitudinal direction of the seat. The longitudinal direction of the seat is considered to be the same as the longitudinal direction of the motor vehicle wherein the seat is mounted. This longitudinal direction X corresponds to the normal direction of advance of the vehicle. The longitudinal direction X is horizontal. The transverse direction Y of the seat thus corresponds to the transverse or lateral direction of the motor vehicle. This transverse direction corresponds to a direction perpendicular to the normal direction of advance of the vehicle. The transverse direction Y is horizontal. Finally, the vertical direction Z is a vertical direction of the seat, perpendicular to the longitudinal and transverse directions.

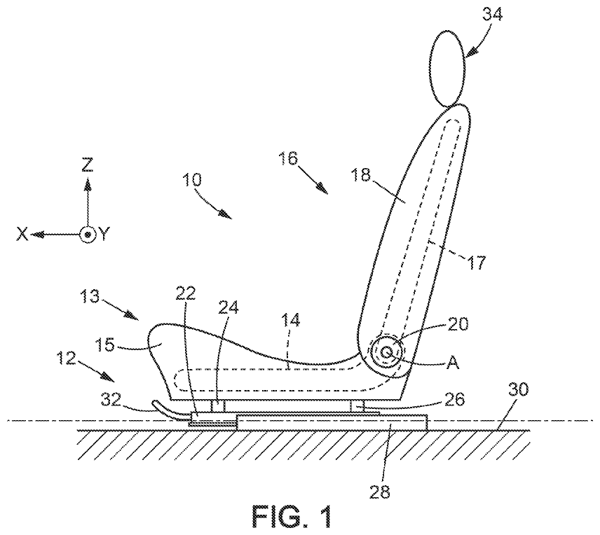

FIG. 1 schematically shows a motor vehicle seat 10 mounted on a mechanism with runners 12.

The seat 10 includes a seat base 13 (or seat cushion), with a seat base frame 14 and a seat base lining 15, on which a backrest 16, with a backrest frame 17 and a backrest lining 18, is mounted. The backrest frame 17 is here pivoting about a transverse axis A, in relation to the seat base frame 14. For this, a hinging mechanism 20 is disposed between the seat base frame 14 and the backrest frame 17.

The seat base 13 is mounted on movable profiles 22, also called slides or male profiles, through the intermediary of feet 24, 26. Each movable profile 22 forms part of a runner 12 and is associated with a fixed profile 28. The fixed profile 28 is called rail or female profile. The fixed profile 28 is fastened to the floor 30 of a motor vehicle.

The seat 10 comprises in this example a manual control element 32, called cross-bar, of sliding control of the runners 12. This manual control element 32 particularly makes it possible to block and unblock systems for stopping the sliding of the movable profiles 22 in relation to the respective fixed profiles 28. Once the stop systems have been unblocked, the manual control element 32 may also be used to make the movable profiles 22 slide in relation to their respective fixed profiles 28 of the runner 12 in the longitudinal direction X of the runners 12. The fixed 28 and movable profiles 22 of the runners 12 are generally metal.

Alternatively, the movement of the movable profiles 22 in relation to the fixed profiles 28 is controlled by means of an actuator.

According to the example illustrated, the seat 10 may also comprise a headrest 34. The headrest 34 may also comprise a headrest frame and a headrest lining.

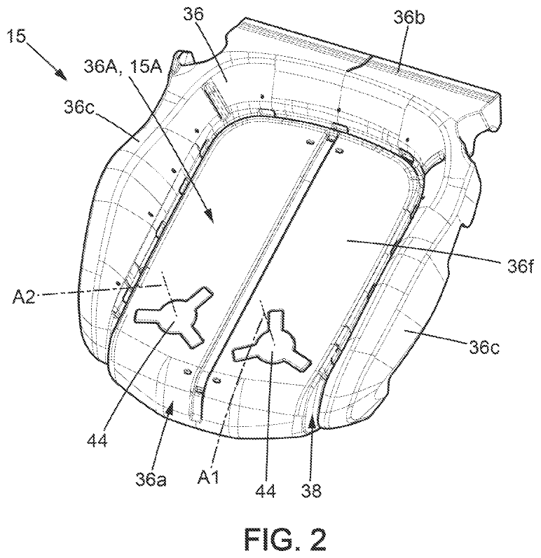

In the following, it is described in more detail an example of seat base lining 15 that may be implemented in the seat 10 in FIG. 1, in comparison to FIGS. 2 to 4.

FIG. 2 more particularly shows the face 15A of the lining 15 intended to be oriented towards an occupant of the vehicle seat.

The lining 15 includes a cushioning 36. The cushioning 36 itself also includes a face 36A intended to be oriented towards an occupant of the vehicle seat 10.

The cushioning 36 is produced here in the form of a foam pad. The cushioning 36 has a cup shape open towards the front 36a . The cushioning thus includes a bottom portion 36f intended to form most of the surface of the cushioning 36 in contact with an occupant of the vehicle seat. The bottom portion 36f is surrounded by a bead forming the sides 36c and the back 36b of the cushioning 36. This cup shape of the cushioning 36b contributes to improving the holding in position of the occupant of the vehicle seat in relation to the seat base 13, and thus the comfort of the vehicle seat. Between the bead and the bottom portion 36f of the cushioning 36, the latter has a groove 38. Here this groove 38 is continuous, which borders the bottom portion 36f on three sides. At the bottom of this groove 38 devices for fastening a cover covering the cushioning 36 may be provided. For example, the cushioning 36 is overmoulded on these fastening devices. These fastening devices, disposed at the bottom of the groove 38, make it possible to satisfactorily fasten the cover, by holding it taut over the cushioning 36, for a better aesthetic effect.

Moreover, in the example illustrated, the cushioning 36 has two holes 40. The two holes are produced here in a front portion of the cushioning 36 corresponding to a front third of the cushioning 36. Indeed, it has been noted that it is at the bottom of the thighs, that vibrations emitted improve more significantly the comfort of an occupant of the seat.

However, in the case where the vibrations are implemented as warning for the occupant of the seat, it is preferred that the vibrations are formed in the middle and/or towards the back of the seat. In this case, holes 40 may be produced in the middle and/or on the back third of the cushioning 36, each hole 40 receiving a vibrating device 42 as is described below.

Here, the holes 40 are blind, in that they only open on one face, in this case the face 36A intended to be oriented towards an occupant of the vehicle seat, of the cushioning 36.

Each hole 40 is here cylindrical. In other words, each hole 40 extends in the direction of a respective axis A1, A2, by having a substantially constant transverse section. Here, the axes A1, A2 of the two holes 40 are parallel. Furthermore, the transverse sections of the two holes 40 are substantially identical. Here, the transverse section of each hole 40 comprises a central portion, substantially in the shape of a disk, of axis the axis A1, A2 of extension of the hole 40. The transverse section of each hole 40 also comprises three rectangular portions extending substantially radially from the central portion. The three rectangular portions are substantially identical. Here, the three rectangular portions are evenly distributed about the respective axis A1, A2 of the hole 40 considered. Thus, each hole 40 is of section substantially complementary to the section of a vibrating device 42, as described later.

Furthermore, each hole 40 is deeper than the height of a vibrating device 42. In particular, each hole 40 may have a depth, measured in the direction of the respective axis A1, A2, between 10 mm and 20 mm deeper than the height of the vibrating device 42 that is received therein. This makes it possible to place a foam pad 44 in the hole 40, on top of the vibrating device 42 that is received therein. The foam pad 44 may plug the hole 40 wherein it is received. In particular, the foam pad 44 may be flush with the surface of the bottom portion 36f of the cushioning 36. This foam pad 40 prevents a direct contact of the occupant of the seat with the vibrating device 42, which improves the comfort of the occupant.

Each foam pad 44 may be made of a foam different from the cushioning 36. In particular, each foam pad 44 may be made of a foam denser than the cushioning 36. Thus, the vibrations of the vibrating device 42 are advantageously guided as a priority by the foam pad 44 towards the occupant of the seat, rather than in the cushioning 36. By way of example, the cushioning 36 may have a density between 30 and 50 kg·m⁻³, whereas the foam pads 44 have a density between 70 and 80 kg·m⁻³. It is thus possible to obtain a better concentration of the effect of the vibrating devices 42, in a small area of the lining 15. This is particularly sought in an application wherein the vibrating devices 42 are implemented to vibrate in harmony with the music played in the motor vehicle, by a HI-FI device of the motor vehicle and/or to massage precise areas of the occupant of the vehicle seat, particularly precise areas of the thighs of the occupant of the vehicle seat.

In the example illustrated, each vibrating device 42 includes a chassis 46, a vibrating element 48 fastened to the chassis 46, and means, not shown, for making the vibrating element 48 vibrate. The means for making the vibrating element 48 vibrate are accessible to the person skilled in the art. These means may for example comprise a coil to make a vibrating body vibrate in the vibrating element 48 made of a magnetic material or integral with a piston made of a magnetic material.

The vibrations of each vibrating device 42 are advantageously directed substantially in the direction of the axis A1, A2 of the vibrating device 42 considered, common to the axis of the hole 40 wherein the vibrating device 42 is received.

Each vibrating device 42 is devoid of any vibrating membrane. Each vibrating device 42 is thus to be distinguished from a loudspeaker in that each vibrating device 42 above all aims to transmit vibrations (or solidborne noise) to the occupant of the vehicle seat, rather than sound (or airborne noise). The vibrations of each vibrating device 42 may particularly be in a range of frequencies that is not audible. The frequencies of the vibrating devices 42 may particularly be outside of the 20 Hz to 20 kHz range. Alternatively or in addition, the vibrating element 48 may have a shape such that these three dimensions are substantially of the same order of magnitude. In particular, a dimension of the vibrating element 48, measured in the direction of the axis A1, A2, of the vibrating device 42, is not 100 times smaller, preferably 10 times smaller, than other dimensions of the vibrating element 42, measured in a plane perpendicular to the axis A1, A2, of the vibrating device 42.

Here, as already mentioned above, the vibrating devices 42 are implemented to vibrate in harmony with the music played by a HI-FI device of the motor vehicle and/or to massage a precise area of an occupant of the vehicle seat.

The vibrating element 48 is here of substantially cylindrical shape, of circular section.

The vibrating element 48 is received in an additional cylindrical portion 46c, of the chassis 46. The cylindrical portion 46c may be plugged on its face intended to be oriented towards the rear face 15B of the lining 15, which is not intended to be oriented towards the occupant of the vehicle seat.

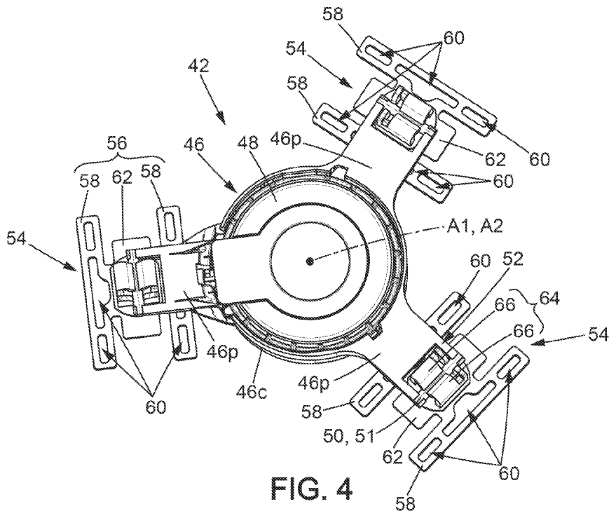

As more particularly seen in FIG. 4, the chassis 46 comprises, further to this cylindrical portion 46c, three lugs 46p. Each of the three lugs 46p has the shape of a substantially rectangular strip. The lugs 46p are here evenly distributed about the axis A1, A2 of the vibrating device 42. Each lug 46p extends mainly in a radial direction, in relation to the axis A1, A2, of the vibrating device 42. Thus, a longitudinal end of each lug 46p is here integral with the cylindrical portion 46c of the chassis 46. The opposite end, hereinafter the free end, of each lug 46p has a snap-fit relief 50, here in the form of a cylindrical rod 51. The rod 51 may particularly be of circular or polygonal, particularly rectangular or square section. The rod 51 extends in an orthoradial direction in relation to the axis A1, A2 of the vibrating device 42. The rod 51 is advantageously of thickness greater than the thickness of the rest of the lug 46p. An opening 52 is produced in each lug 46p, in the vicinity of the rod 51.

Each rod 51 is fastened by snap-fitting on a bracket 54 of the vibrating device 42. Thus, each vibrating device 42 is fastened here to three brackets 54 evenly distributed angularly about the axis A1, A2 of the vibrating device 42. A better stability of the vibrating device is thus obtained. It is however possible to implement only two brackets 54, or at least three brackets that are not evenly distributed angularly about the axis A1, A2 of the vibrating device 42. The latter solution has the advantage of creating a locating notch for fastening the vibrating device 42 on the brackets 54. Exactly three brackets 54 evenly distributed angularly have however the advantage of a better balance of the vibrating device 42 fastened to these brackets 54, while limiting the contact surface of the brackets with the foam of the lining.

Furthermore, the implementation of distinct brackets 54 limits the contact surface of these brackets 54 with the cushioning 36. Thus, the diffuse propagation of the vibrations emitted by a vibrating device 42 towards the cushioning 36 is limited. In other words, each vibrating device 42 is thus isolated as best as possible in relation to the cushioning 36, by limiting the contact surface of the brackets 54 with the cushioning 36. This makes it possible to also improve the feeling of vibrations of the vibrating device(s) in one or more localised areas or points.

Each bracket 54 first of all includes a base 56. The base 56 has for example a length, measured in an orthoradial direction in relation to the axis A1, A2 of the vibrating device 42 considered between 30 mm and 45 mm. The base 56 has for example a width, measured in a radial direction in relation to the axis A1, A2 of the vibrating device 42 considered, between 20 mm and 30 mm. Furthermore, each bracket 54 has for example a height of 15 mm.

Here, the base 56 of each bracket 54 comprises first of all two lateral tabs 58 with holes 60. The lateral tabs 58 are substantially flat, extending in a plane normal to the axis A1, A2. The holes 60 favour the fastening of the brackets 54 in the cushioning 36, particularly in the case where the cushioning 36 is overmoulded on the brackets 54. The holes 60 in the lateral tabs 58 thus make it possible to effectively fasten the base 56 of the brackets 54 in the cushioning 36.

The base 56 of each bracket 54 also comprises a central tab 62. The central tab 62 extends between the two respective lateral tabs 58 of the base 56 of the bracket 54 considered. The central tab 62 also extends, preferably, in a plane normal to the axis A1, A2. Here, the central tab 62 of the base 56 of the brackets 54 is solid, that is to say devoid of holes.

Each bracket 54 also comprises a snap-fit relief 64 additional to the snap-fit relief 50 at the free end of the lugs 46p . Here, each snap-fit relief 64 takes the form of two folded elastic strips 66, leaving between them a passage of thickness, measured in a radial direction in relation to the axis A1, A2, less than the thickness of the rod 51 at the free end of a lug 46p. The two strips 66 are for example symmetrical with one another, in relation to a plane extending between the two strips 66. One of the strips 66 is partially received in the opening 52 in the vicinity of the rod 51. Thus, the snap-fitting of the rod 51 on the bracket 54 is performed by pushing in the vibrating device 42 in the direction of the axis A1, A2, the rod 51 moving the two folded strips 66 apart until reaching a point between the free end of the folded strips 66 and the base 56 of the bracket 54. Advantageously, the base 54 has a housing for receiving the rod 51, the free end of the strips 66 holding in position the rod 51 in the receiving housing.

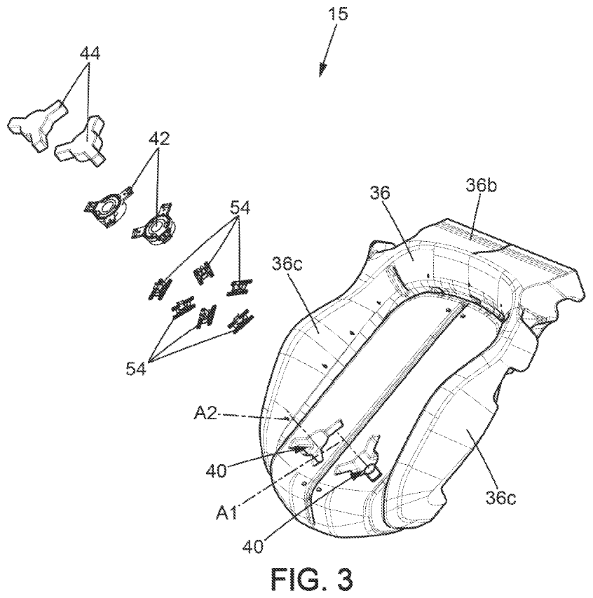

The lining 15 of FIGS. 2 and 3 may particularly be produced by implementing the following method.

In a first step, the cushioning 36 is overmoulded on the brackets 54, by forming the two blind holes 40. Here, it is also ensured that the snap-fit reliefs of the brackets 54 protrude into the holes 40, as well as the receiving housing of the rod 51, if applicable.

A vibrating device 42 is then inserted into each of the holes 40 and then fastened by snap-fitting, that is to say by cooperation of the additional snap-fit reliefs 50, 64 of the brackets 54, on the one hand, and of the vibrating device 42 on the other hand.

Finally, a foam pad 44 is inserted into each hole 40, to plug it.

Thus, the lining 15 may be produced easily. Nevertheless, the lining 15 ensures a satisfactory comfort for the occupant of a seat the seat base of which is equipped with such a lining 15. In particular, the presence of foam pads 44 contributes to limiting the feeling of the vibrating devices 42 by the occupant of the seat, when the vibrating devices are not implemented.

Finally, the fastening of the vibrating devices 42, each with the aid of a plurality of distinct and spaced brackets 54, limits the propagation of vibrations of the vibrating devices 42 in the cushioning 36. It is thus possible to better guide the vibrations produced by the vibrating devices 42, towards the occupant of the seat, via the foam pads 44. This guidance is also improved here, when the foam pads 44 have a density greater than the density of the cushioning 36.

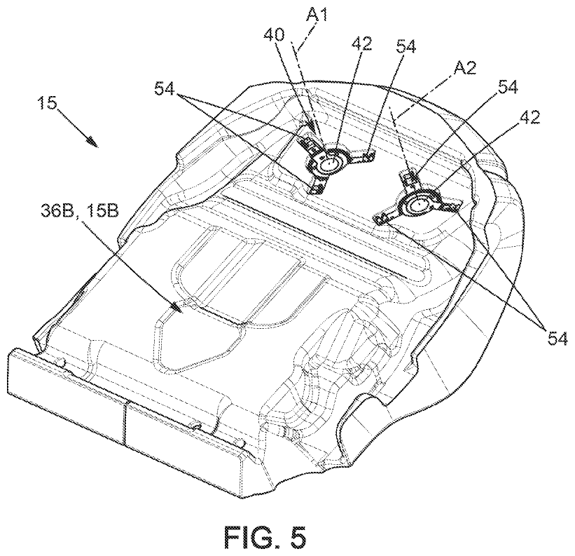

FIG. 5 illustrates a second example of lining 15. According to this second example, the holes 40 open on the face 36B of the cushioning 36, opposite the face 36A intended to be oriented towards an occupant of the vehicle seat.

In this case, the holes 40 are also, preferably, blind, in that they do not open on the face 36A of the cushioning 36 intended to be oriented towards the occupant of the seat. On the contrary, a cushioning thickness is advantageously maintained between the bottom of the holes 40 and the face 36A of the cushioning 36 intended to be oriented towards the occupant of the seat. This cushioning 36 thickness is for example greater than or equal to 10 mm, preferably greater than or equal to 15 mm and/or less than or equal to 30 mm, preferably less than or equal to 20 mm.

In addition, in this case, the cushioning 36 is overmoulded on the brackets 54 in such a way that the snap-fit reliefs 64 of the brackets 54 protrude into the holes 40. The vibrating devices 42 are then fastened in the holes 40, by cooperation of the snap-fit reliefs 50, 64.

In this second example, a priori it is not necessary to plug the holes 40 with a foam pad 44 as in the case of the first example. Thus, there is a saving on foam pads and manufacturing steps.

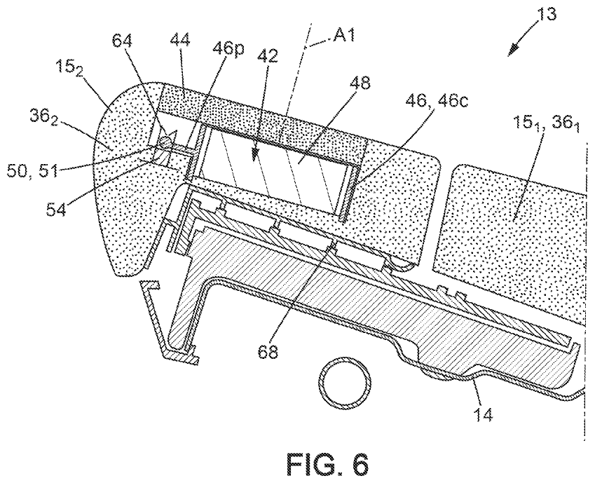

FIG. 6 shows a variant of the seat base 13 of FIG. 1.

According to the example illustrated in this FIG. 6, the seat base 13 is of adjustable length. For this, the lining 15 is produced here in two distinct portions 15₁, 15₂. A first portion of lining 15₁, comprising a first cushioning portion 36₁, is fastened in relation to the seat base frame 14. A second portion of lining 15₂, comprising a second cushioning portion 36₂, is fastened on a bracket 68 movable in longitudinal translation in relation to the seat base frame 14. It is then possible to equip the second portion 15₂ of the lining with vibrating devices 42, as has been described above. The solutions described above are particularly well adapted to be implemented in this case. Indeed, the solutions proposed a priori do not need any particular bracket for a vibrating device 42, on the movable bracket 68. Furthermore, the linings obtained are substantially identical to comparative linings that do not integrate a vibrating device 42. Thus, the solutions described above may easily be implemented to produce a lining portion intended to be fastened on a movable bracket.

The assembly of the movable bracket 68 and of the second portion of lining 15₂ is called seat base front (or seat cushion nose).

Firstly, the examples presented are seat base or seat base front linings. However, it is possible to equip the lining of any seat element with at least one vibrating device. In particular, the lining of a vehicle seat backrest, of a headrest or even of a motor vehicle seat armrest may thus be equipped with at least one vibrating device.

In the case of a backrest, it is preferable that the vibrating devices 42 are disposed in the lower portion of the backrest, particularly in the bottom third of the backrest, when the purpose of the vibrations emitted is to improve the comfort of the occupant of the seat. In the case where the vibrations are implemented to warn the occupant of the seat, it is then preferred to position vibrating devices substantially in the middle of the backrest and/or in the bottom portion of the backrest. In this case, the vibrating devices may particularly be disposed in the two bottom thirds of the backrest.

In the examples described, two vibrating devices are each time disposed in the lining considered. Of course, this number of vibrating devices is not limiting. Thus, the lining may include a single vibrating device or more than two vibrating devices.

Moreover, in the examples illustrated, each rod 51 is connected to the cylindrical portion 46c of the chassis of the vibrating device 42, by a lug 46p. Alternatively, however, the rod 51 is integral with the cylindrical portion 46c of the chassis, only by the two arms delimiting the opening 52 intended to receive a strip 66. Thus, a substantially more compact assembly is obtained.

In addition, in the examples presented, the lugs 46p extend substantially in a plane normal to the axis A1, A2 of the vibrating device 42 considered. Alternatively or in addition, the lugs 46p may extend parallel to the axis A1, A2 of the vibrating device considered.

Finally forms of snap-fit reliefs may be implemented other than those described above. However, the examples described have the advantage of being easy to produce, compact and reliable.

A vibrating device (also called “vibrator” or “exciter”) may be integrated into a vehicle seat. Such a vibrating device may particularly be implemented to warn the occupant of the vehicle seat of a danger. Such a seat is therefore more particularly intended for the driver of the motor vehicle.

One difficulty specific to the integration of such a comparative vibrating device into a motor vehicle seat is to reconcile the comfort of the occupant and the perception by the occupant of the warning when the vibrating device is implemented.

Thus, placing the comparative vibrating device in contact with the occupant of the seat makes it possible to obtain desired perception. In this case, however, the comfort of the occupant is considerably deteriorated, who constantly feels a contact with the comparative vibrating device.

In addition, fastening such a comparative vibrating device on a frame of the seat tends to generate vibrations of this frame, by reaction to the implementation of the comparative vibrating device. Here again, the comfort of the occupant of the seat is then too deteriorated for this solution to be able to be retained.

Finally, it has been imagined to fasten a comparative vibrating device in the lining of the motor vehicle seat, particularly in the foam of this lining. The first solutions envisaged have not made it possible to completely solve the aforementioned problems. Thus, it has been proposed to overmold the foam pad on the comparative vibrating device. In this case, however, a distribution of the vibration of the comparative vibrating device occurred, making its perception by the occupant of the vehicle seat more delicate.

A comparative seat base lining comprising a cushioning obtained by overmolding a support plate in such a way as to arrange a housing adapted to receive a vibrator. The vibrator is subsequently fastened on the plate, for example by clipping. The housing is then plugged by placing therein a foam pad. The vibrations emitted by the vibrator propagate to the cushioning, via the plate. Vibrations are transmitted to places that are not in line with the vibrator. The comparative seat base lining makes the propagation of the vibrations of the vibrator more diffuse.

Therefore, there is still a need for a motor vehicle seat element lining comprising a vibrating device, and not having at least some of the aforementioned drawbacks.

To this end, it is described a vehicle seat element lining comprising:

a cushioning comprising at least one first face intended to be oriented towards an occupant of the vehicle seat and a second face, opposite the first face, the cushioning having at least one hole opening on the first and/or the second face of the cushioning,

at least one vibrating device, each vibrating device being disposed in a respective hole, each vibrating device comprising at least two first snap-fit reliefs,

a plurality of distinct vibrating device brackets, each comprising a base, overmolded by the cushioning, and a second snap-fit relief, each vibrating device being fastened to at least two respective brackets, by snap-fitting a first snap-fit relief with a second snap-fit relief.

Thus, advantageously, the cushioning makes it possible to absorb the vibrations emitted by the vibrating device that would tend to propagate in the frame equipped with the lining. Furthermore, the use of distinct brackets makes it possible to limit the transmission of vibrations emitted by each vibrating device to the cushioning.

According to preferred embodiments, the vehicle seat element lining comprises one or more of the following features, taken alone or in combination:

each hole opens on a single face of the cushioning, within the first face and the second face of the cushioning;

each hole opens on the first face of the cushioning, the hole preferably being plugged on the side of the first face of the cushioning, by a foam pad, attached in the hole and distinct from the cushioning, the foam pad being, also preferably, denser than the cushioning;

each hole opens on the second face of the cushioning, each hole preferably being devoid of foam pad plugging the hole on the side of the second face of the cushioning;

each vibrating device comprises a chassis forming the at least two first snap-fit reliefs, and a vibrating element fastened to the chassis;

the chassis includes a cylindrical portion mainly extending along a longitudinal axis and receiving the vibrating element, the at least two snap-fit reliefs being integral with the cylindrical portion;

each first snap-fit relief is connected to the cylindrical portion by a lug preferably extending radially and/or axially in relation to the cylindrical portion;

each second snap-fit relief comprises two elastic strips symmetrical in relation to a plane extending between the two strips, each strip comprising a free end folded in the direction of the other strip, the distance between the two free ends of the two strips being less than the thickness of the associated first snap-fit relief;

each first snap-fit relief comprises a cylindrical rod, preferably extending orthoradially in relation to the longitudinal direction of the cylindrical portion, if applicable;

each vibrating device comprises three distinct first snap-fit reliefs, particularly exactly three distinct first snap-fit reliefs, the three first snap-fit reliefs preferably being evenly distributed about the longitudinal axis of the cylindrical portion, if applicable;

the base of each bracket comprises a first tab, preferably two first tabs extending on either side of a second tab, each first tab preferably having holes, each first tab being overmoulded by the cushioning; and

the seat element is one of a seat base, a backrest, a headrest, an elbow rest, and a seat front of a length-adjustable seat base.

According to another aspect, it is also described a motor vehicle seat comprising a seat base with a seat base frame, a backrest with a backrest frame, and at least one vehicle seat element lining such as described above, in all its combinations, each vehicle seat element lining preferably being fastened to the seat base frame, to the backrest frame or to a movable bracket in relation to the seat base frame.

According to another aspect, it is described a method for manufacturing a vehicle seat element lining such as described above, in all its combinations, comprising the steps of:

i) providing the vibrating device brackets;

ii) overmoulding the cushioning on the vibrating device, the overmoulding being performed in such a way as to form the at least one hole opening on the first and/or the second face of the cushioning;

iii) inserting a vibrating device into each of at least one hole and fastening each vibrating device to the vibrating device brackets by snap-fitting the first and second snap-fit reliefs.

Preferably, the at least one hole opening on the first face of the cushioning and the method comprises a step iv) subsequent to step iii) of plugging each hole on the side of the first face of the cushioning by means of a foam pad.

1. A vehicle seat element lining comprising:
a cushioning comprising at least one first face intended to be oriented towards an occupant of the vehicle seat and a second face, opposite the first face, the cushioning having at least one hole opening on at least one among the first and the second face of the cushioning,
at least one vibrating device, each vibrating device being disposed in a respective hole, each vibrating device comprising at least two first snap-fit reliefs, and
a plurality of distinct vibrating device brackets, each comprising a base, overmoulded by the cushioning, and a second snap-fit relief, each vibrating device being fastened to at least two respective brackets, by snap-fitting a first snap-fit relief with a second snap-fit relief.

2. The vehicle seat element lining of claim 1, wherein each hole opens on a single face of the cushioning, among the first face and the second face of the cushioning.

3. The vehicle seat element lining of claim 1, wherein each hole opens on the first face of the cushioning.

4. The vehicle seat element lining of clam 3, wherein the hole is plugged on the side of the first face of the cushioning, by a foam pad, attached in the hole and distinct from the cushioning.

5. The vehicle seat element lining of claim 4, wherein the foam pad is denser than the cushioning.

6. The vehicle seat element lining of claim 1, wherein each hole opens on the second face of the cushioning.

7. The vehicle seat element lining of claim 6, wherein each hole is devoid of foam pad plugging the hole on the side of the second face of the cushioning.

8. The vehicle seat element lining of claim 1, wherein each vibrating device comprises a chassis forming the at least two first snap-fit reliefs, and a vibrating element fastened to the chassis.

9. The vehicle seat element lining of claim 8, wherein the chassis includes a cylindrical portion mainly extending along a longitudinal axis and receiving the vibrating element, the at least two snap-fit reliefs being integral with the cylindrical portion.

10. The vehicle seat element lining of claim 9, wherein each first snap-fit relief is connected to the cylindrical portion by a lug.

11. The vehicle seat element lining of claim 10, wherein each lug extends along at least one among a radial direction and an axial direction, in relation to the cylindrical portion.

12. The vehicle seat element lining of claim 11, wherein each second snap-fit relief comprises two elastic strips symmetrical in relation to a plane extending between the two strips, each strip comprising a free end folded in the direction of the other strip, the distance between the two free ends of the two strips being less than the thickness of the first associated snap-fit relief.

13. The vehicle seat element lining of claim 1, wherein each first snap-fit relief comprises a cylindrical rod.

14. The vehicle seat element lining of claim 1, wherein each vibrating device comprises three distinct first snap-fit reliefs.

15. The vehicle seat element lining of claim 14, wherein each vibrating device comprises a chassis forming the at least two first snap-fit reliefs, and a vibrating element fastened to the chassis, wherein the chassis includes a cylindrical portion mainly extending along a longitudinal axis and receiving the vibrating element, and wherein the three first snap-fit reliefs are evenly distributed around the longitudinal axis of the cylindrical portion.

16. The vehicle seat element lining of claim 1, wherein the seat element is one of a seat base, a backrest, a headrest, an elbow rest, and a length-adjustable seat base front of a seat base.

17. The vehicle seat element lining of claim 1, wherein the base of each bracket comprises a first tab.

18. A motor vehicle seat comprising a seat base with a seat base frame, a backrest with a backrest frame, and at least one vehicle seat element lining according to claim 1.

19. A method for manufacturing the vehicle seat element lining according to claim 1, comprising the steps of:
i) providing the vibrating device brackets;
ii) overmolding the cushioning on the vibrating device brackets, the overmoulding being produced in such a way as to form the at least one hole opening on at least one among the first and the second face of the cushioning; and
iii) inserting a vibrating device into each of at least one hole and fastening each vibrating device to the vibrating device brackets by snap-fitting the first and second snap-fit reliefs.

20. The method of claim 19, the at least one hole opening on the first face of the cushioning, the method comprising a step iv) subsequent to step iii) of plugging each hole on the side of the first face of the cushioning by means of a foam pad.
